(19) United States
(12) Patent Application Publication
(10) Pub. No.: US 2012/0178480 A1
(43) Pub. Date: Jul. 12, 2012

(54) MESSAGING SYSTEMS AND METHODS

(75) Inventors: Yogesh B. Patel, Mountain View, CA (US); Sabeer Bhatia, San Francisco, CA (US)

(73) Assignee: SABSE TECHNOLOGIES, INC., Mountain View, CA (US)

(21) Appl. No.: 13/225,002

(22) Filed: Sep. 2, 2011

Related U.S. Application Data
(60) Provisional application No. 61/379,866, filed on Sep. 3, 2010.

(51) Int. Cl. H04W 4/12; H04W 4/14

(52) U.S. Cl. 455/466

(57) ABSTRACT

Systems and methods communicate information between mobile devices. A message having a destination address is received from a messaging application running on a first mobile device. A data store that stores addresses of devices subscribing to the messaging server is searched for the destination address, and if the destination address is found, the message is pushed to a second messaging application running on the destination device. If the destination address is not found, the message is formatted as a generic message and sent to a service provider of the destination device.

### RELATED APPLICATIONS

This application claims priority to U.S. Patent Application Ser. No. 61/379,866, titled “Messaging Systems and Methods”, filed Sep. 3, 2010, which is incorporated herein by reference.

### BACKGROUND

Short Message Service (SMS) is a text messaging service offered over mobile phone networks. Specifically, the SMS data is transferred over the call channel of the mobile phone network at a relatively low data rate. Even where the mobile phone network service provider offers a separate data channel, the SMS text is still transferred over the slower call channel. Messaging applications running on mobile device can send messages there between. However, to receive these messages, the destination device must be running the messaging application.

### SUMMARY OF THE INVENTION

In an embodiment, a messaging server delivers a message addressed to a destination device from a source device. A messaging application operational on the source device inputs the message and a destination address of the destination device. A messaging server is in communication with the messaging application via a data channel. The messaging server includes a data store for storing an address of each of a plurality of devices subscribed to the messaging server, a destination lookup module for searching the data store for the destination address, and a message formatter for formatting the message as a generic message if the destination address is not found in the data store.

In another embodiment, a method communicates information between mobile devices. A message having a destination address is received from a messaging application running on a first mobile device. A data store that stores addresses of devices subscribing to the messaging server is searched for the destination address, and if the destination address is found, the message is pushed to a second messaging application running on the destination device. If the destination address is not found, the message is formatted as a generic message and sent to a service provider of the destination device.

In another embodiment, a messaging system delivers information of a first message received in a first format from a source device to a destination device. The messaging system include a messaging application operational on the source device for inputting the information and sending the first message in the first format and addressed to the destination device. The messaging system also includes a messaging server in communication with the messaging application via a data channel. The messaging server has a data store for storing an address of each device connected to the messaging server and running a copy of the messaging application, and a destination lookup module for searching the data store for the destination device address. The messaging server also has a message formatter for (a) sending the first message to the destination device via the data channel if the destination device address is found in the data store, and for (b) generating a second message in a second format and based upon the information if the destination device address is not found in the data store.

### BRIEF DESCRIPTION OF THE FIGURES

FIG. 1 shows one exemplary messaging system for conveying a message over a data channel from a first device, in one embodiment.

FIG. 2 shows the messaging server of FIG. 1 in further detail and exemplifying delivery of a message to a phone.

FIG. 3 is a flowchart showing one exemplary messaging method, in one embodiment.

### DETAILED DESCRIPTION OF THE DRAWINGS

In the following description, the phone is used as an exemplary device having messaging capability through a cell phone service provider. However, the phone may also represent other mobile devices that have messaging capability, such as an Apple® iPAD™, e-book readers, tablet computers, personal digital assistants, etc.

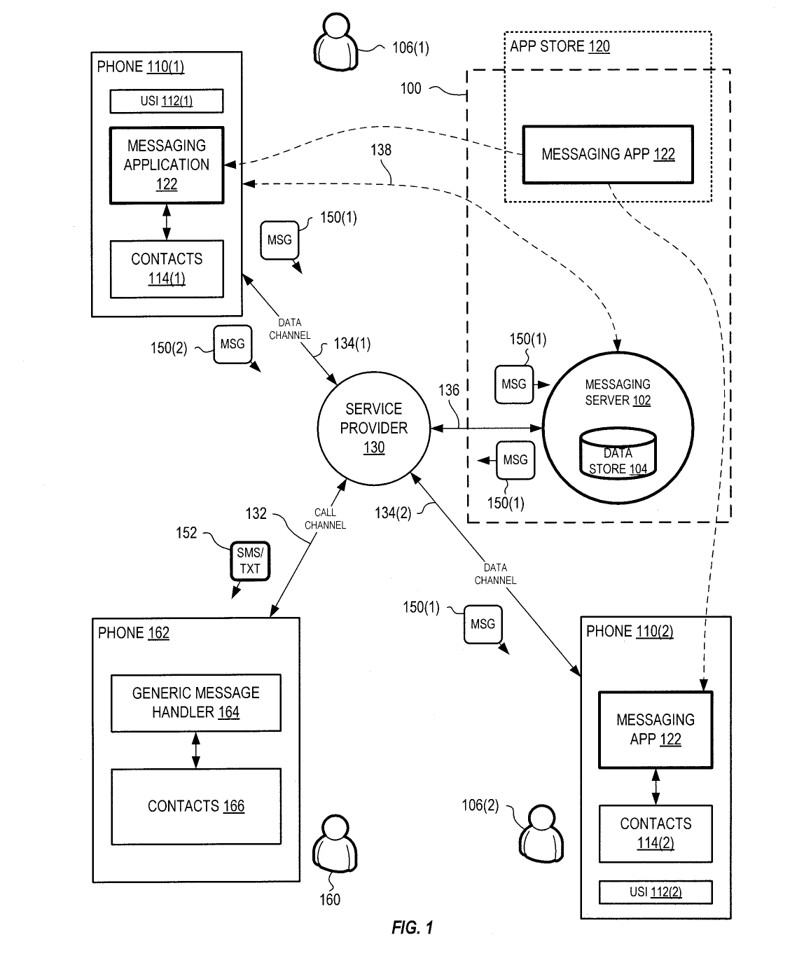

FIG. 1 shows one exemplary messaging system 100 for conveying a message over a data channel from a first device. System 100 has a messaging server 102 (e.g., a cloud-based server having Internet and/or other connectivity) and a messaging application 122 that is made available to user 106 through an application store 120. Messaging server 102 includes a data store 104 (e.g., a database) for storing information of a plurality of subscribers (e.g., users 106) to services of messaging server 102. In the example of FIG. 1, each user 106 has a phone 110 with a unique security identifier (USI) 112 and an address book of contacts 114. USI 112 is. for example. a security identity module (SIM) as used with Global System for Mobile Communications (GSM) carriers or an International Mobile Equipment Identity (IMEI) as used with non-GSM carriers.

Each phone 110 connects to a service provider 130 via a call channel (e.g., call channel 132) that provides voice call and Short Message Service (SMS) text messaging connectivity, and a data channel 134 that provides a faster data transfer capability and Internet connectivity. Typically, a service provider (e.g., service provider 130) offers a data plan for unlimited data transfer to a device (e.g., phone 110) registered for that plan. Thus, use of the data channel, once purchased, does not cost extra. Although one service provider is shown within FIG. 1, messaging server 102 may connect to more than one service provider without departing from the scope hereof. For example, phone 110(1) may utilize a first service provider, and phone 110(2) may utilize a different service provider, wherein both service providers connect to messaging server 102 via Internet connectivity 136. In addition to data channel 134, phone 110 may connect to messaging server 102 via an alternate data channel 138 that is not provided by service provider 130, such as a WiFi Internet connection.

Messaging application 122 provides a messaging service that utilizes one of data channels 134 and 138 instead of call channels 132, but may be otherwise similar to messaging services (e.g., SMS/txt, multimedia messaging service (MMS), picture message, voice message, video message, etc.) provided by service provider 130. Messaging application 122 may use contacts 114 of phone 110 to determine a destination for a message 150, or may allow user 106 to enter a destination address (e.g., a phone number of a destination device), and provide a central application for handling all messaging service of phone 110.

User 106 may download messaging application 122 from application store 120 to phone 110 (or downloads/installs application 122 via any other medium or method), and then messaging application 122 and phone 110 are automatically registered with messaging server 102 through interaction with messaging application 122. Messaging application 122 may read a security number (e.g., the assigned phone number of phone 110) from USI 112, or read the assigned phone number from another source within phone 110, and send that number to messaging server 102 during the registration process, and when sending each message, if such security is desired.

Messaging server 102 is primarily Internet connected 136 (e.g., messaging server 102 is a cloud computing device) that receives messages 150 from messaging application 122 via (a) data channel 134 of service provider 130 and Internet connectivity 136 or (b) directly via data channel 138 from the phone (e.g., WiFi to Internet connectivity and other such data connections). Upon receiving message 150, messaging server 102 looks up a destination address of message 150 within data store 104 to determine whether the device having that destination address is a subscriber of messaging server 102 (and whether that device is currently connected via a data channel 134 or any other channel like WiFi connection to messaging server 102). For example, messaging application 122 may periodically interact with messaging server 102 to indicate that it is connected to messaging server 102, whereupon messaging server 102 may store indication of such connectivity within data store 104 and push received messages for that messaging application.

In the example of FIG. 1, user 106(1) utilizes messaging application 122 on phone 110(1) to send a message 150(1) to user 106(2) of phone 110(2). Message 150(1) is transferred from messaging application 122 on phone 110(1) to messaging server 102 via data channel 134(1) and Internet connectivity 136. If messaging server 102 determines (e.g., by lookup within data store 104) that phone 110(2) is currently ‘online’, then messaging server 102 sends message 150(1) to messaging application 122 of phone 110(2) via service provider 130 and data channel 134(2). Messaging server 102 may also send message 150(1) to messaging application 122 of phone 110(2) via an alternate data channel (e.g., a WiFi Internet connection similar to data channel 138) when available (e.g., as indicated by data store 104 based upon recent connectivity of phone 110(2)).

Messaging server 102 many also store message 150, within data store 104 for example, if phone 110(2) is currently ‘offline’. In one embodiment, messaging server 102 selects an alternative data channel to send message 150 if phone 110(2) is currently ‘offline’. In an alternative embodiment, if phone 110(2) is currently “offline,” messaging server 102 may store message 150 within data store 104 for a predefined period (e.g., 30 minutes). If, within that predefined period, phone 110(2) becomes “online,” messaging server 102 sends message 150 to messaging application 122 running on phone 110(2). If that predefined period expires, messaging server 102 may send message 150 to phone 110(2) using an alternative data off, such as via service provider 130. Messaging server 102 may use other rules for delivering message 150, without departing from the scope hereof.

In a second operational example, user 106(1) utilizes messaging application 122 of phone 110(1) to send a message 150(2) to a user 160 of a phone 162 that does not include messaging application 122. Phone 162 includes a generic message handler 164 that may interface to contacts 166 of phone 162 and operate to create and display generic (e.g., SMS/txt, MMS, picture, video, voice) messages in cooperation with service provider 130. Upon receipt of message 150(2) by messaging server 102, data store 104 is searched for the address of recipient phone 162, which in this example is not found because messaging application 122 has not been downloaded onto phone 162 and is therefore not registered with messaging server 102. Since, within messaging server 102, phone 162 is not determined as connected to messaging server 102 via a data channel (e.g., data channel 134 or 138), messaging server 102 sends message 150(2) to service provider 130 for delivery as a generic message 152. Specifically, messaging server 102 generates generic message 152 as at least one SMS/txt message, since message 150(2) contained only text, and sends it to the service provider of phone 162 for delivery to phone 162.

Unlike other messaging systems that utilize a phone based application and require the recipient to be running that application, messaging server 102 does not require the destination device (i.e., phone 162) to be running messaging application 122. Messaging server 102 may send information of message 150 to any service provider for delivery to any destination device anywhere in the world. That is, messaging server 102 converts the message received from messaging application 122 of phone 110(1) into a format suitable for display on destination phone 162. For example, if message 150(2) contains video, messaging server 102 may convert message 150(2) into an MMS message for display on phone 162. If message 150(2) contains only text, messaging server 102 may generate one or more SMS/txt messages for display on phone 162. Specifically, where the destination device is not known to messaging server 102, messaging server 102 converts the received message (e.g., generic message 152(2)) into the most economical format for the receiving device. In one example of operation, messaging server 102 selects the less expensive data path for delivery of message 150.

As is currently typical, service providers (e.g., service provider 130) may charge for sending and delivery of generic messages (e.g., SMS/txt messages, MMS message, picture message, video message, and voice messages). For example, in the USA, many service providers charge the sender for sending an SMS/txt message and charge the recipient for delivery of that SMS/txt message. Where messaging server 102 reformats a message from messaging application 122 into a generic message (e.g., generic message 152) for delivery, the associated service provider (e.g., service provider 130) may charge messaging server 102 for sending the message, and may charge user 160 to receive the message. As with other messaging application based systems, it is therefore advantageous to utilize messaging application 122 for both sending and receiving messages 150, however, unlike other messaging application based systems, system 100 also delivers messages to non-subscribing devices.

In one embodiment, to encourage uptake of messaging application 122, messaging server 102 may append an advertisement for messaging application 122 at the end of generic message 152, such that user 160 may learn of an alternative to using generic message handler 164. In another embodiment, to encourage uptake of messaging application 122, messaging server 102 may send a separate generic message to the recipient, informing the user that they may download messaging application 122 for handling SMS/txt/MMS/picture/Voice/Video messages.

To prevent fraudulent sending of messages (e.g., spam), messaging application 122 may read identification information from USI 112 for inclusion with each message 150 sent from phone 110. This identification information is then validated by messaging server 102 prior to pushing or sending the message to the destination device, and the message is only delivered if the identification information matches the expected sender of the message.

Where phone 110 has an alternate connection to the Internet (e.g., data channel 138), messages 150 may be sent and received over that connection, particularly where that connection is faster than data channel 134. In one example, messaging application 122 forms a peer-to-peer communication channel to messaging server 102 to transfer message 150 (sending and/or receiving).

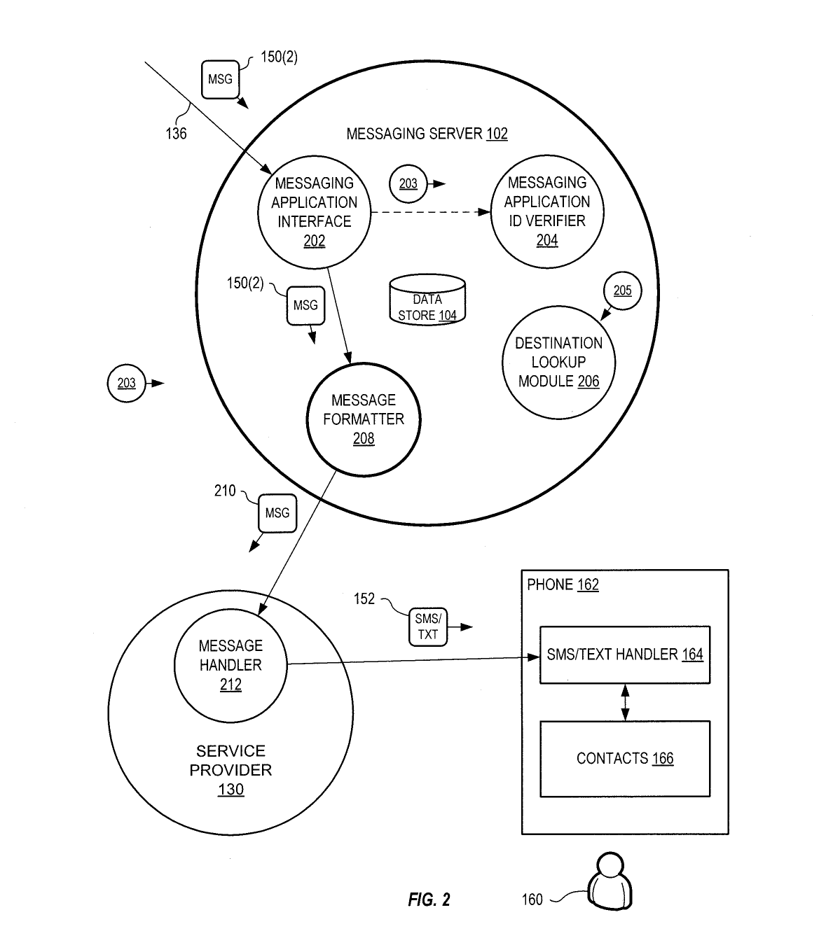

FIG. 2 shows, in further detail, messaging server 102, exemplifying delivery of message 150(2) to phone 162 of user 160. Messaging server 102 is shown with a messaging application interface 202, a messaging application ID verifier 204, a destination lookup module 206, and a message formatter 208. In one example of operation, message 150(2) is received, via Internet connectivity 136, by messaging application interface 202. Messaging application ID verifier 204 receives a messaging application ID 203 received within message 150(2) from messaging application interface 202. Messaging application ID verifier 204 then performs a lookup of messaging application ID 203 within data store 104 to ascertain whether messaging application 122 is registered with messaging server 102.

Destination lookup module 206 receives a destination address 205, received within message 150(2) from messaging application 122 of phone 110(1), and searches for that address within data store 104 to determine whether the destination device is currently connected with messaging server 102. In the example of FIG. 2, destination lookup module 206 does not find destination address 205 within data store 104, and therefore instructs messaging application interface 202 to forward message 150(2) to message formatter 208.

In one example of operation, message formatter 208 formats message 150(2) to form message 210 for output to a message handler 212 of service provider 130. That is, since service provider 130 provides service to phone 162, messaging server 102 formats received message 150(2) to form message 210 and sends message 210 to message handler 212 of service provider 130 for output as generic message 152 to phone 162. Format of message 210 may be similar to generic message 152. Where permitted, messaging server 102 inserts the caller ID of the message sender within the generic message (e.g., generic message 152). Thus, if a user 160 replies to the generic message 152, the reply is sent directly to the sender of the message. However, since the replied does not use messaging server 102, a cost may be incurred.

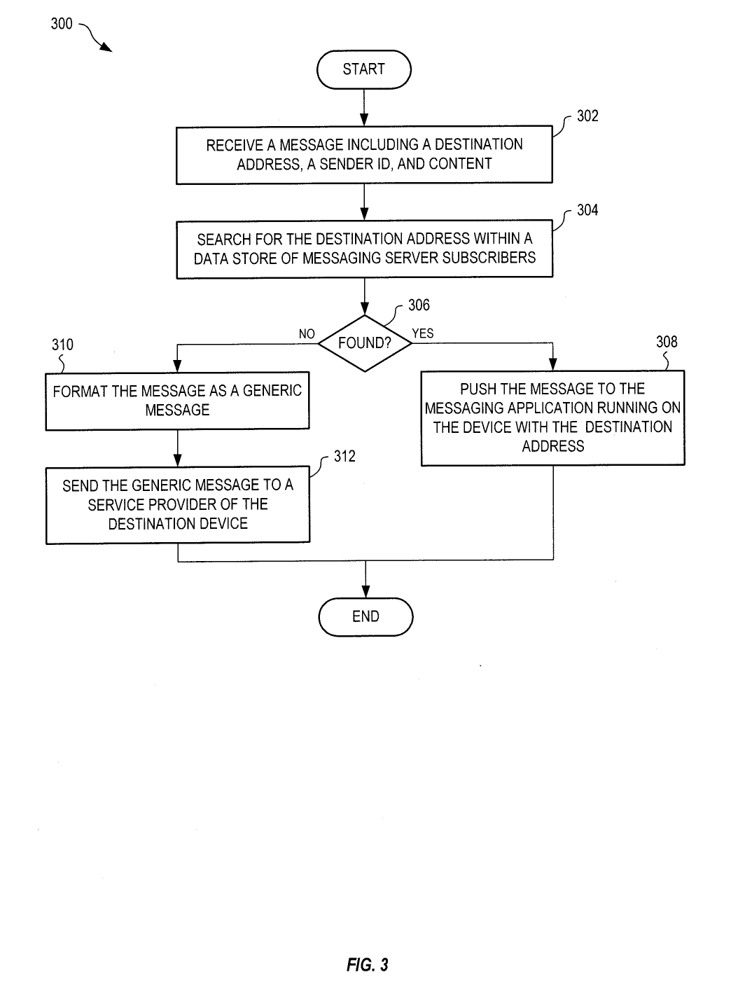

FIG. 3 is a flowchart showing one exemplary messaging method 300. Method 300 is implemented within messaging server 102, FIG. 1, for example. In step 302, a message including a destination address, a sender ID, and content is received. In one example of step 302, message 150(2) is received from messaging application 122 running on phone 110(1). In step 304, a search is made for the destination address within a database of messaging service subscribers. In one example of step 304, destination lookup module 206 searches data store 104 for destination address 205.

If, in step 306, method 300 determines that the destination address was found within the data store, method 300 continues with step 308; otherwise, method 300 continues with step 310. In step 308, the message is pushed to the messaging application running on the device with the destination address. In one example of step 308, message 150(1) is pushed to messaging application 122 running on phone 110(2). Method 300 then repeats for the next received message.

In step 310, the message is formatted as a generic message. In one example of step 310, message formatter 208 formats message 150(2) to form message 210. In step 312, the generic message is sent to a service provider of the destination device. In one example of step 312, message 210 is sent to message handler 212 of service provider 130 for delivery to phone 162.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A messaging server for delivering a message addressed to a destination device from a source device comprising:
a messaging application operational on the source device for inputting the message and a destination address of the destination device; and
a messaging server in communication with the messaging application via a data channel, the messaging server comprising:
a data store for storing an address of each of a plurality of devices subscribed to the messaging server;
a destination lookup module for searching the data store for the destination address; and
a message formatter for formatting the message as a generic message if the destination address is not found in the data store.

2. The messaging system of claim 1, wherein the generic message comprises one of a short message service (SMS) message, a multimedia messaging service (MMS) message, a picture message, a voice message, and a video message.

3. The messaging system of claim 1, wherein the message formatter sends the message to the destination device based upon the destination address if the destination address is found in the data store.

4. The messaging system of claim 1, the data channel comprising the Internet.

5. The messaging system of claim 1, the messaging server further comprising a messaging application ID verifier for blocking the message if the ID of the messaging application cannot be verified.

6. The messaging system of claim 5, wherein the messaging application reads the ID of the source device from a unique security identifier of the source device.

7. A method for communicating information between mobile devices comprising:
receiving, within a messaging server, a message having a destination address from a messaging application running on a first mobile device;
searching for the destination address within a data store of the messaging server that stores addresses of devices subscribing to the messaging server;
if the destination address is found, pushing the message to a second messaging application running on the destination device; and
if the destination address is not found:
formatting the message as a generic message; and
sending the generic message to a service provider of the destination device.

8. The method of claim 7, further comprising:
receiving, from the messaging application, the identification of the first mobile device from a unique security identifier of the first mobile device; and
registering the messaging application with the messaging server in association with the identification.

9. The method of claim 7, further comprising storing the message for later delivery if the destination address is found and the destination device is not online.

10. The method of claim 7, further comprising selecting a format for the generic message based upon cost.

11. A messaging system for delivering information in a first message received in a first format from a source device to a destination device comprising:
a messaging application operational on the source device for inputting the information and sending the first message to the destination device, in the first format and;
a messaging server in communication with the messaging application via a data channel, wherein the messaging server comprises:
a data store for storing an address of each device connected to the messaging server;
a destination lookup module for searching the data store for the destination device address; and
a message formatter for (a) sending the first message to the destination device via the data channel if the destination device address is found in the data store, and for (b) generating a second message in a second format and based upon the information if the destination device address is not found in the data store.

12. The messaging system of claim 11, wherein the second format is compatible with one of: the short message service (SMS), the multimedia messaging service (MMS), a picture message, a video message, and a voice message.

13. The messaging system of claim 12, the second message comprising one or more SMS texts.

14. The messaging system of claim 11, wherein the data channel comprises the Internet.
